(19) United States
(12) Patent Application Publication
(10) Pub. No.: US 2018/0360097 A1
(43) Pub. Date: Dec. 20, 2018

(54) DEVICE FOR CUTTING A COCONUT

(71) Applicant: Pumatik Small Kitchen Appliances Private Limited, Bangalore (IN)

(72) Inventor: Wilson Varghese Mattathil, Bangalore (IN)

(21) Appl. No.: 16/060,693

(22) PCT Filed: Dec. 9, 2016
(86) PCT No.: PCT/IB2016/057485

§ 371 Date: Jun. 8, 2018

(30) Foreign Application Priority Data
Dec. 11, 2015 (IN) 6653/CHE/2015
Dec. 7, 2016 (IN) 201641041771

(51) Int. Cl. A23N 5/03; B26D 3/30

(52) U.S. Cl. CPC A23N 5/03; B26D 3/30

(57) ABSTRACT

The Present disclosure discloses a device for cutting a coconut, the device comprising a support structure; a coconut clasper mounted on the support structure and having a pair of opposed jaws adapted for clasping opposed ends of a coconut, each jaw being rotatable about an axis to permit rotation of a coconut clasped in the jaws; and a cutter mounted on the support structure and positioned for cutting a coconut clasped in the jaws, wherein the device includes a coconut centring mechanism to cause simultaneous movement of the jaws to align the mid-point of a coconut clasped in the jaws with the position of the cutter, such that, in use, the cutter acts at approximately the mid-point of the coconut.

### CROSS REFERENCE

This application is a national application of and claims priority from PCT/IB2016/057485 filed Dec. 9, 2016 and claims priority from Indian Patent Application No. 6653/CHE/2015 filed on Dec. 11, 2015 and Indian Patent Application No.

201641.041771 filed on Dec. 7, 2016.

### TECHNICAL FIELD

This invention relates to a device for cutting a coconut, and in particular, to a device for cutting a coconut into two approximately equal halves with minimal manual input.

### BACKGROUND OF THE DISCLOSURE

Coconut is the fruit of the coconut palm. It is made up of a thick fibrous fruit coat known as the husk, a hard protective endocarp or shell (hereafter called shell) and a fleshy middle layer known as the kernel. While the present invention may be used with both husked and de-husked coconuts, the term “coconut” is generally used herein to refer to a de-husked coconut.

The shape of a de-husked coconut varies from elongated oval to almost spherical, with variation in length and width. The coconut has three eyes at one end and a seam running between any two of the eyes to the opposed end. The two opposed ends of the coconut can be considered its “poles” and a line around its circumference equidistant between the poles its “equator”. If a cut is made along this “equator” the coconut is cut into two approximately equal halves. However, due to the variability in shape, length and width it is a challenge to cut a coconut to two equal or approximately equal halves.

Currently, domestic methods for cutting a coconut into two halves include hitting the coconut with a heavy knife or hitting the coconut against a hard surface. These methods are manually intensive, inconvenient and not very efficient. They also pose a risk of injury to the user's hands. Furthermore, unless the user is experienced, these methods result in the coconut splitting into two uneven sized pieces such that one piece is very small and one very large, with uneven edges. This makes the coconut difficult to use generally, and in particular, makes the coconut difficult to grate.

Devices for cutting a coconut are known.

CN 204070438 U, for example, describes a coconut cutting machine comprising a frame, a rotatable coconut holder mounted on the frame and a coconut cutting device. In use, a coconut is clamped in the coconut holder and aligned with the coconut cutting device by the user. A motor is used to rotate the coconut as it is cut.

U.S. Pat. No. 2,456,446 describes a coconut peeling machine having an axially-disposed, outwardly-facing, blade-like cutter. The cutter blades have their cutter edges concavely curved so as to serve as fan blades. In use, a coconut is held by the user and engaged with the cutter for peeling.

U.S. Pat. No. 1,438,714 describes a machine for automatically extracting and shredding the meat from a coconut. The machine comprises, inter alia, a holder for gripping one end of a coconut, a cooperative holder movable relative to the first holder for gripping the other end of the coconut and a dividing tool for separating the coconut between its ends. In use, a coconut is clamped in the machine by moving the cooperative holder relative to the first holder such as to grip the coconut at each end. A motor is used to rotate the coconut as it is cut.

U.S. Pat. No. 4,350,088 describes a coconut cutter comprising a rotatable coconut holder and a coconut cutting assembly. The coconut cutting assembly comprises a C-shape body that is designed to be secured around the coconut by the user, preferably aligned with its transaxial centre plane. The cutting assembly includes cutting knives that cut the coconut as it is rotated within the cutting assembly by the coconut holder.

A problem with the cutting devices of CN 204070438 U, U.S. Pat. No. 2,456,446, U.S. Pat. No. 1,438,714 and U.S. Pat. No. 4,350,088 however, is that they still require considerable input from user and are not convenient to use. In addition, and in the case of U.S. Pat. No. 2,456,446 and U.S. Pat. No. 4,350,088 especially, the devices pose significant risk of injury to the user.

There is a need therefore to provide an improved device for cutting a coconut.

### SUMMARY OF THE DISCLOSURE

In a first aspect, the invention provides a device for cutting a coconut, the device comprising a support structure; a coconut clasper mounted on the support structure and having a pair of opposed jaws adapted for clasping opposed ends of a coconut, each jaw being rotatable about an axis to permit rotation of a coconut clasped in the jaws; and a cutter mounted on the support structure and positioned for cutting a coconut clasped in the jaws, wherein the device includes a coconut centring mechanism to cause simultaneous movement of the jaws to align the mid-point of a coconut clasped in the jaws with the position of the cutter, such that, in use, the cutter acts at approximately the mid-point of the coconut.

Advantageously, by providing a pair of opposed jaws that permit rotation of a coconut clasped in the jaws, and which are mounted for simultaneous movement by a coconut centring mechanism to align the mid-point of a coconut clasped in the jaws with the position of the cutter, a simple device in accordance with the invention is able to clasp a coconut and cut it into two approximately equal halves with minimal manual input.

The cutter is preferably structured so as to cause rotation of a coconut clasped in the jaws as it acts on the coconut. This may, for example, be achieved with a circular cutting blade. Rotation of the coconut as the cutter acts on it enables the cutter to cut along the entire circumference of the coconut without changing position. Rotation by the cutter also eliminates the need for motorised or manual rotation of the coconut. Alternatively, the coconut may be rotated by means of a manual rotating handle or a motor.

In order to control the rotation of a coconut clasped in the jaws, the cutter may include driving gear as well as cutting blade, the cutting blade being structured and arranged so as to cut through a coconut, and the driving gear being adapted to engage with the surface of a coconut clasped in the jaws such as to cause it to rotate at a predetermined speed. It will be appreciated that controlled rotation of the coconut is important to ensure that the entire circumference of the coconut is cut by the cutter.

In order to prevent loss of the water contained in the coconut as it is cut, the cutter preferably includes adjustable limiting means structured so as to limit the depth that the cutter can cut into a coconut clasped in the jaws. Such limiting means can be configured, for example, to ensure that the kernel of the coconut is not cut through, thus retaining the water in the coconut. Preservation of the kernel structure also means that the coconut can remain securely clasped in the jaws of the coconut clasper, even after the shell is cut through.

To avoid risk of injury to the user, the device of the invention may comprise a cutter guard mounted on the cutter and structured so as to encase at least a cutting edge of the cutter, the cutter guard being movable relative to the cutter so as to permit exposure of the cutting edge when it is brought into contact with a coconut. Preferably, the cutter guard encases the entire blade of the cutter.

The cutter guard may be configured to collect a maximum amount of the dust and debris created when a coconut is cut by the cutter. For example, the cutter guard can be designed to hang vertically lower than the cutting blade, so as to be in the path where dust and debris from the cutting has maximum probability of falling. The cutter guard is preferably detachable from the cutter. This allows easy disposal of the dust and debris and convenient access to the cutting blade.

The cutter may include any commercially available saw blade used for cutting Laminate, Plywood, MDF and Chipboard. Preferably, the cutter has a cutting blade structured so as to pull dust and/or debris out of the cut as it is created during the cutting. This may, for example, be achieved with a Triple Chip Grind (TCG) blade. Such blades are particularly effective at pulling out dust or debris formed when cutting a coconut and expelling the waste along the direction of rotation where it can be collected and giving a smooth edge. If a rough edge (cut shell) is needed a different type of blade could be used.

When small notches or irregularities are required in the cut coconut shell, the cutter may comprise a circular cutting blade having outer cutting teeth and inner marking teeth, the outer cutting teeth being adapted to cut through a coconut, and the inner marking teeth being configured such as to create notches in the shell of the coconut. Different kinds of notches can be made by changing the profile of the inner marking teeth.

In order to minimise manual input, the coconut clasper may include a locking means adapted to reversibly lock the opposed jaws in a clasping position. Preferably, the locking means comprises a ratchet and pawl mechanism to allow controlled and incremental tightening of the opposed jaws.

To return the coconut clasper to a position that can accept a coconut, the coconut clasper may include a release mechanism, resiliently biased such as to cause the opposed jaws to separate. The release mechanism preferably comprises a spring arranged such that it is compressed as the opposed jaws are brought together.

The coconut centring mechanism may comprise a rack and pinion mechanism. When a rack and pinion mechanism is used, simultaneous movement of the opposed jaws is smooth and easily controlled. The opposed jaws may be mounted on the rack and pinion mechanism such that one or both of the jaws is detachable.

To help the user align a coconut in the coconut clasper, the opposed jaws may be shaped such as to permit the opposed ends of a coconut to be visible when the coconut is clasped in the jaws. This may, for example, be achieved using ring-shaped jaws. When ring-shaped jaws are used, the user can align the coconut by centring the poles of the coconut in the middle of the ring.

To prevent a coconut from slipping when it is clasped in the jaws, the opposed jaws may include guide ribs structured and arranged such as to grip the coconut. This prevents the coconut from rotating independently of the jaws. The presence of guide ribs also helps the user to properly align the coconut within the jaws.

In order to securely clasp a coconut in the opposed jaws, the coconut clasper may include urging means adapted to engage with one of the opposed jaws so as to urge the jaw into contact with a coconut clasped in the jaws. This may, for example, be achieved by fixing a spring to each jaw, such that the spring is compressed and in tension when a coconut is clasped in the jaws. This extra urging means ensures that the coconut is clasped tightly while it is being cut, even if any gaps arise due to cutting or realignment of the coconut. This extra urging means can also prevent damage to the coconut clasper due to over-tightening of the jaws.

Preferably, the support structure includes at least one base support roller positioned for supporting a coconut clasped in the jaws of the coconut clasper, the at least one base support roller being rotatable about an axis to aid rotation of a coconut clasped in the jaws, and the coconut clasper is mounted on the support structure between the cutter and the at least one base support roller via a clasper connect, the clasper connect being movable relative to the at least one base support roller and the cutter, such that, in use, the coconut clasper can be positioned such that the approximate mid-point of a coconut clasped in its jaws is supported by the at least one base support roller as the cutter acts at the approximate mid-point of the coconut. This arrangement ensures that a coconut clasped in the jaws of the coconut clasper is supported at its mid-point as it is cut. Preferably, the support structure includes two base support rollers that are positioned such that the weight of the coconut is evenly balanced between them.

### BRIEF DESCRIPTION OF THE ACCOMPANYING DRAWINGS

Preferred embodiments of the invention will be further described with reference to the accompanying figures in which:

FIG. 1 is a perspective view of a preferred coconut clasper in accordance with the invention, without its front cover attached.

FIG. 2 is a perspective view of the back of the coconut clasper illustrated in FIG. 1.

FIG. 3 is an exploded view of one of the jaws illustrated in FIGS. 1 and 2.

FIG. 4 is a front view of the coconut clasper illustrated in FIGS. 1-3, clasping a coconut.

FIG. 5 is a sectional view of the coconut clasper illustrated in FIGS. 1-4, showing the release mechanism.

FIG. 6 is a perspective view of the front cover of the coconut clasper illustrated in FIGS. 1-5.

FIG. 7 is a perspective view of the coconut clasper illustrated in FIGS. 1-6, with its front cover attached.

FIG. 8 is a perspective view of a more preferred coconut clasper in accordance with the invention.

FIG. 9 is an exploded view of one of the jaws illustrated in FIG. 8.

FIG. 10 is an enlarged view of one of the jaws illustrated in FIGS. 8 and 9.

FIG. 11 is a perspective view of an alternative coconut clasper in accordance with the invention, clasping a coconut.

FIG. 12 is a perspective view of a preferred cutter in accordance with the invention.

FIG. 13 is an alternative perspective view of the cutter illustrated in FIG. 12.

FIG. 14 includes three different perspective views of the second housing gear illustrated in FIGS. 12 and 13.

FIG. 15 includes two enlarged views of part of the cutter assembly illustrated in FIGS. 12-14, one view with all three frames (left) and one with the external frames removed (right).

FIG. 16 is a perspective view of a cutter guard in accordance with the invention.

FIG. 17 is a perspective view of part of the cutter assembly illustrated in FIGS. 12-15 encased in the cutter guard, without the external frames on the cutter.

FIG. 18 is a perspective view of part of the cutter assembly illustrated in FIGS. 12-15 encased in the cutter guard, with the external frames on the cutter.

FIG. 19 is a side view of part of the cutter assembly illustrated in FIGS. 12-15 encased in the cutter guard, aligned with the mid-point of a coconut.

FIG. 20 is a side view of part of the cutter assembly illustrated in FIGS. 12-15 encased in the cutter guard, starting to act on a coconut.

FIG. 21 is a side view of part of the cutter assembly illustrated in FIGS. 12-15 encased in the cutter guard, acting on a coconut and controlling its rotation.

FIG. 22 is a side view of part of the cutter assembly illustrated in FIGS. 12-15 showing how the cutting depth can be predetermined.

FIG. 23 is a perspective view of a preferred cutting blade in accordance with the invention.

FIG. 24 is a perspective view of a preferred support structure in accordance with the invention.

FIG. 25 is a perspective view of the support structure illustrated in FIG. 24, with a mounted coconut clasper connector.

FIG. 26 is a perspective view of the support structure illustrated in FIG. 24, with a mounted cutter.

FIG. 27 is a perspective view of the coconut clasper illustrated in FIGS. 8-10 arranged to be loaded with a coconut.

FIG. 28 is a perspective view of a preferred device in accordance with the invention, clasping a coconut.

### DETAILED DESCRIPTION

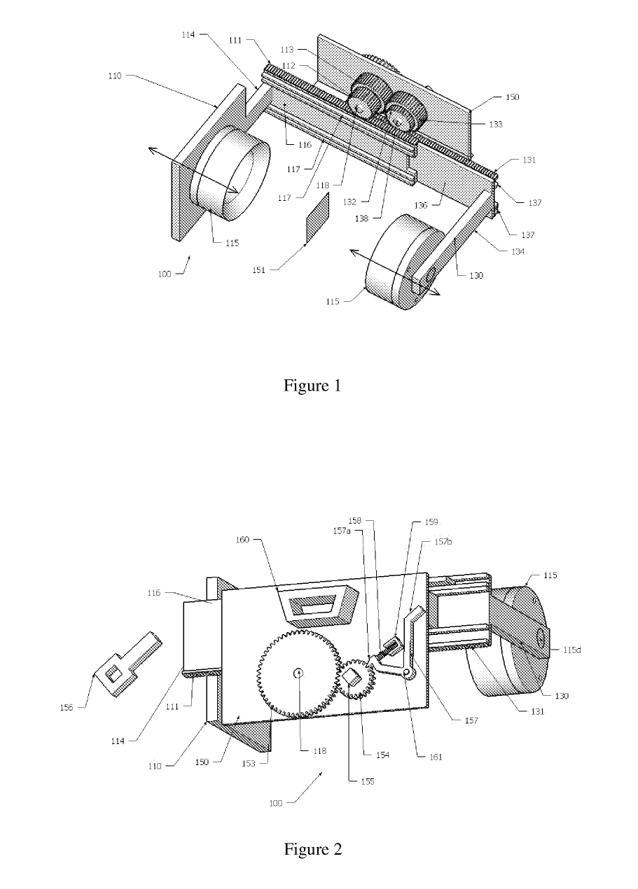

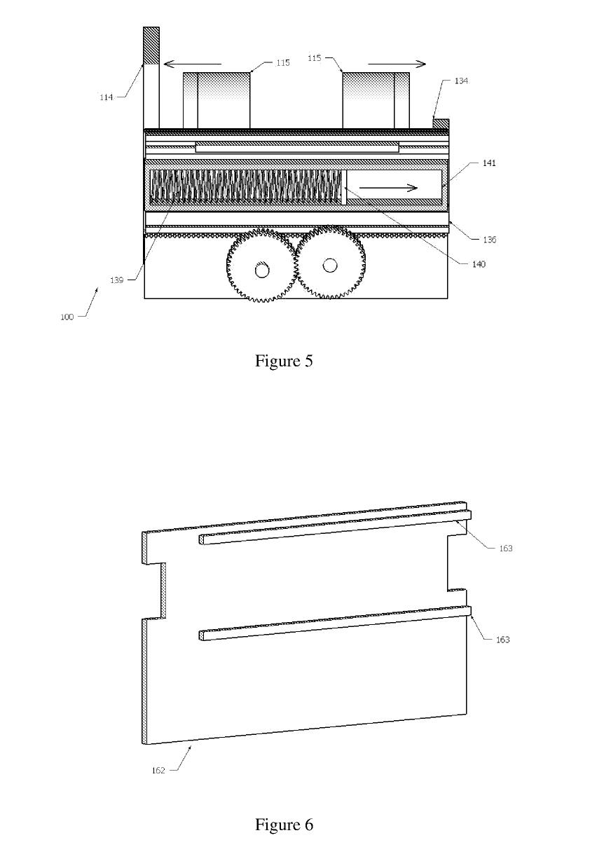

The coconut clasper 100 shown in FIGS. 1-7 has a pair of opposed jaws 115 mounted on arms 110 and 130. Each arm 110 and 130 includes a rack 111, 131, an upper pinion 112, 132, a lower pinion 113, 133, a forearm 114, 134, a back arm 116, 136, railings 117, 137 and a rod 118, 138. Both upper pinions 112, 132 and both lower pinions 113, 133 have the same diameter, respectively.

The upper pinion 112, 132 and the lower pinion 113, 133 of each arm 110, 130 are connected together by the rod 118, 138 of the arm to rotate as one. The upper pinion 112, 132 of each arm 110, 130 is also connected to the rack 111, 131 of the arm via geared teeth in a “rack and pinion” type of connection respectively.

The lower pinions 113 and 133 are connected to each other via geared teeth. This connection ensures that, in use, movement of the first arm 110 towards the second arm 130 causes the second arm 130 to move towards the first arm 110 by an equal distance. This means that if an imaginary line is drawn between the pair of opposed jaws 115, its mid-point will always be same (illustrated in FIG. 1 by mid-point 151). Whether the jaws 115 move towards each other or away from each other therefore, they will always be equidistant from the mid-point 151.

Accordingly, if an almost geometrically evenly shaped object, like a coconut 10, is placed between the jaws 115, the approximate mid-point of this object will coincide with the mid-point 151 of the jaws 115.

The coconut clasper 100 also includes a back support 150, through which the rod 118 of the first arm 110 freely passes and is fixed to a first gear 153. First gear 153 is arranged such that it rotates upon rotation of the upper pinion 112 and the lower pinion 113 of the first arm 110.

A second gear 154 is also provided on the back support 150 and is arranged such as to be rotated by rotation of the first gear 153. The second gear 154 is associated with a lock lever 157. The lock lever 157 includes a lock lever gear end 157a that locks into the teeth of the second gear 154, a lock lever flat end 157b that can be depressed to release the lock on the second gear 154, a lock lever spring 158 to ensure tension in the lock lever 157 and maintain the lock on the second gear 154 and a spring holder 159 to position the lock lever spring 158 optimally. The lock lever 157 rotates about a pivot 161 which is fixed to the back support 150.

A keyin 155 is fixed to the second gear 154 and a key lever 156 is provided to rotate it such that when key lever 156 is turned, it turns the second gear 154 which in turn rotates the first gear 153 and thereby moves the opposed jaws 115. The second gear 154 is smaller than the first gear 153 in order to provide more torque to turn using the key lever 156. This gear ratio also ensures better control in having small incremental movement between the opposed jaws 115 by larger rotation of the second gear 154. This larger rotation also ensures that larger gear teeth can be used in the second gear 154 for the lock lever gear end 157a to engage and lock. Key lever 156 can have a gear arrangement inside such that it slips when over-tightened.

A female connector 160 is also provided on the back support 150.

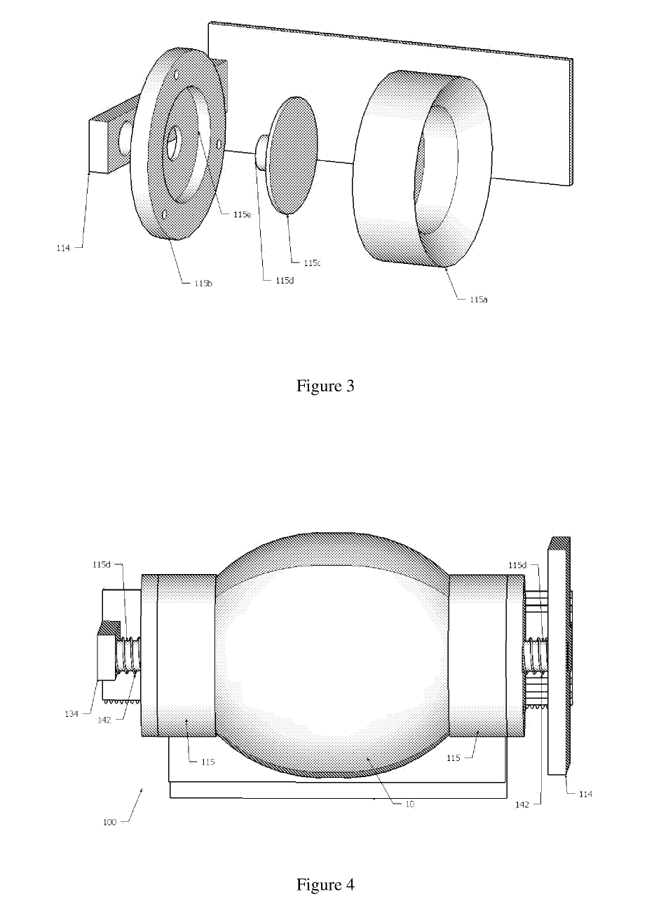

A jaw 115 of this embodiment is shown in FIG. 3 to include an outer portion 115a, a support portion 115b having a through hole and a plate depression 115e, and an inner plate 115c. The inner plate 115c has an inner rod 115d formed on its surface. The depth and diameter of plate depression 115e is higher than the thickness and diameter of the inner plate 115c, such that the inner plate 115c can fit inside the plate depression 115e to rotate freely and move horizontally. If it is required for this rotation to be restricted the inner plate 115 could be made more abrasive, for example, by sticking abrasive material on it, or the diameter of the plate depression 115e could be decreased to make it a tighter fit. The inner rod 115d passes freely through the hole in the support portion 115b and is fixed to the hole in the forearm 114, 134. This ensures that jaw 115 can rotate freely about forearm 114 and 134 and also move horizontally a little.

Each inner rod 115d has an urging spring 142 wound around it. The urging spring 142 is arranged between the jaw 115 and the forearm 114, 134 of each arm 110, 130, such that it is compressed and in tension when a coconut is clasped in the jaws 115. The inclusion of urging spring 142 ensures that adequate tension or pressure is maintained on the coconut 10 by the jaws 115 while it is being cut and allows for any gaps arising due to cutting or realignment of the coconut. The urging spring 142 also prevents the user from damaging the coconut clasper 100 by over-tightening the keyin 155.

The coconut clasper 100 has a release mechanism to cause the opposed jaws 115 to separate. The release mechanism includes a release spring 139, a spring box 141 for housing the release spring 139 and a spring peg 140. The spring peg 140 is attached to the back arm 136 of the second arm 130 and is configured to block one end of the release spring 139.

When the opposed jaws 115 are moved towards each other, spring peg 140 pushes on the release spring 139 and compresses it. At the same time, lock lever 157 allows the jaws 115 to move towards each other but prevents them from separating again. From this configuration, the lock on the second gear 154 can be released by depressing the lock lever flat end 157b to rotate the lock lever 157 about pivot 161 and move the lock lever gear end 157a out from the teeth of the second gear 154. When the second gear 154 is unlocked, the release spring 139 decompresses pushing the spring peg 140 and the back arm 136 outward. This results in the opposed jaws 115 moving away from each other automatically. When pressure on lock lever flat end 157b is removed the lock lever gear end 157a reverts back to locking the second gear 154 due to the tension in lock lever spring 158.

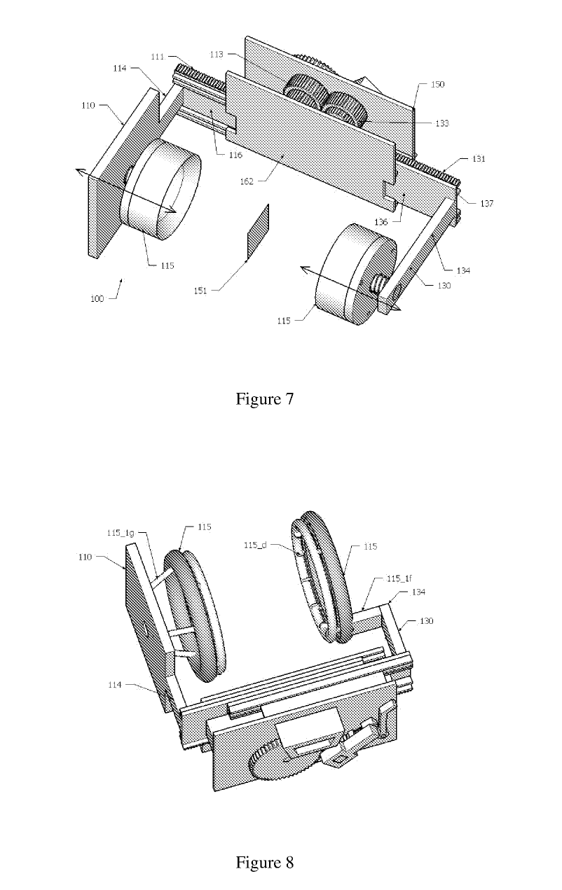

As shown in FIGS. 6 and 7, the coconut clasper 100 has a front cover 162 with railing supports 163. The front cover 162 is used as the front cover over the back arms 116 and 136. Railing supports 163 interlink with the railings 117 on the first arm 110 such that back arms 116 and 136 move horizontally and smoothly.

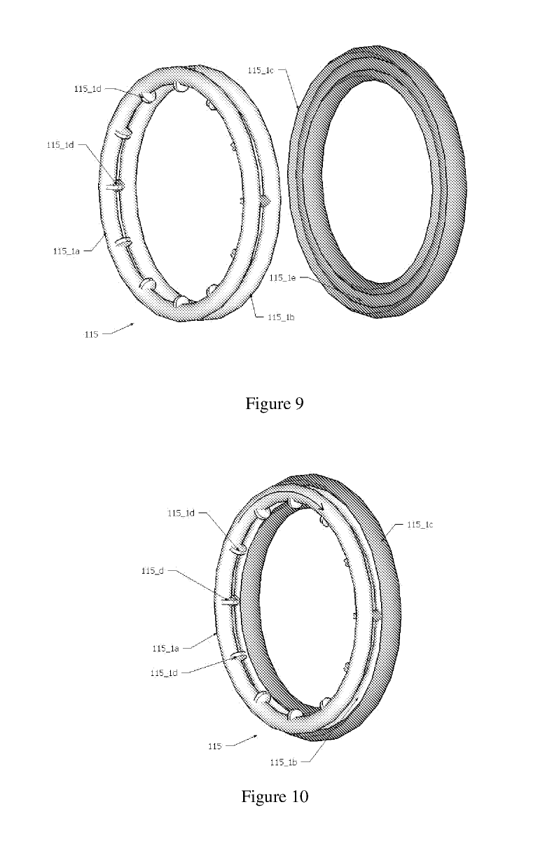

The coconut clasper 100 shown in FIGS. 8-10 has a pair of opposed jaws 115 with a clasping ring 115_1a and a bearing ring 115_1b. Clasping ring 115_1a has several guide ribs 115_1d formed on it that help to guide a coconut 10 into it. Bearing outer 115_1c has bearing depression 115_1e which is a smooth hollow with an inner diameter slightly more than the diameter of bearing ring 115_1b. Bearing ring 115_1b fits into bearing depression 115_1e such that the clasping ring 115_1a can smoothly rotate (as shown by arrow about bearing outer 115_1c). The jaws 115 can be fitted onto forearms 114 and 134 through connection with the bearing outer 115_1c, e.g., through connection 115_1g or connection 115_1f. This embodiment enables the user to see the opposed ends of a coconut 10 while its held in the coconut clasper 100 thereby enabling the user to align the coconut 10 properly.

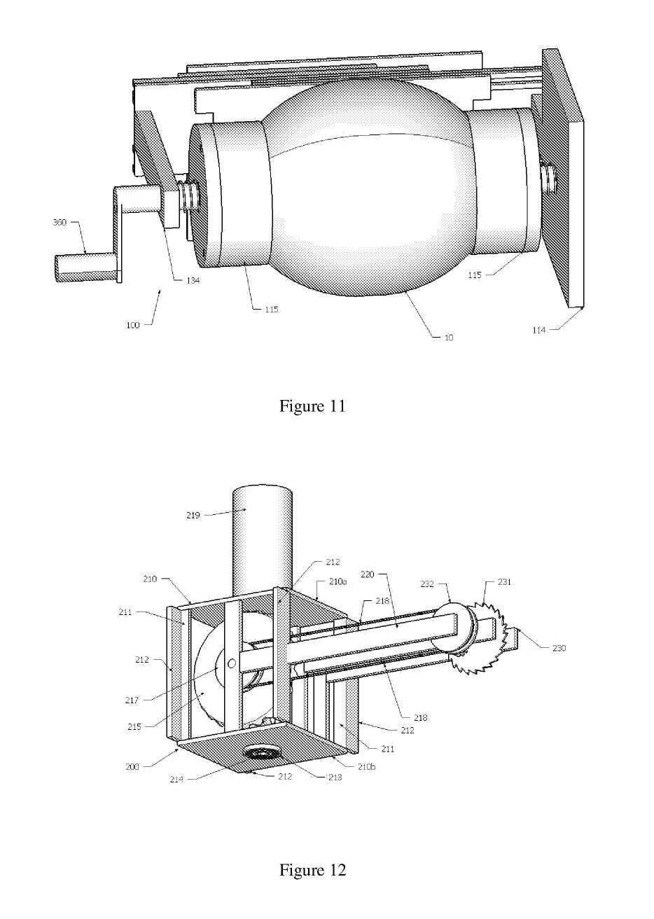

The coconut clasper 100 shown in FIG. 11 has a manual turner 360. The manual turner 360 can be used to turn the jaw 115 of the second arm 130 which in turn rotates the coconut 10 and the jaw 115 of the first arm 110.

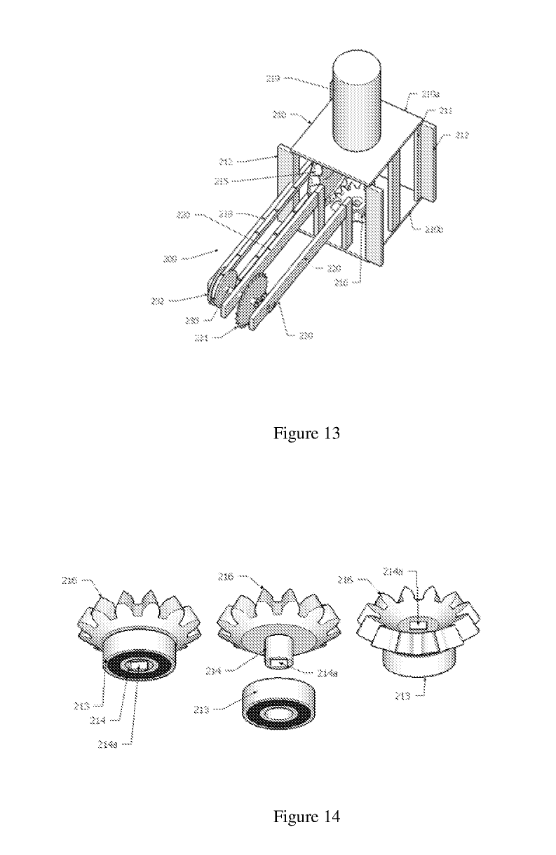

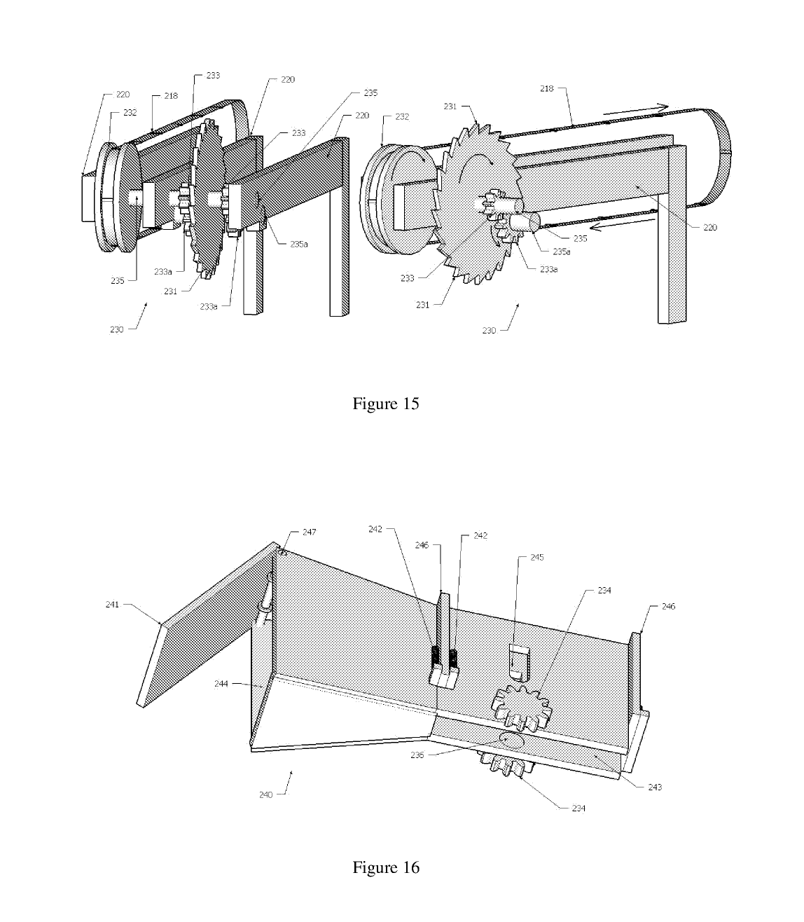

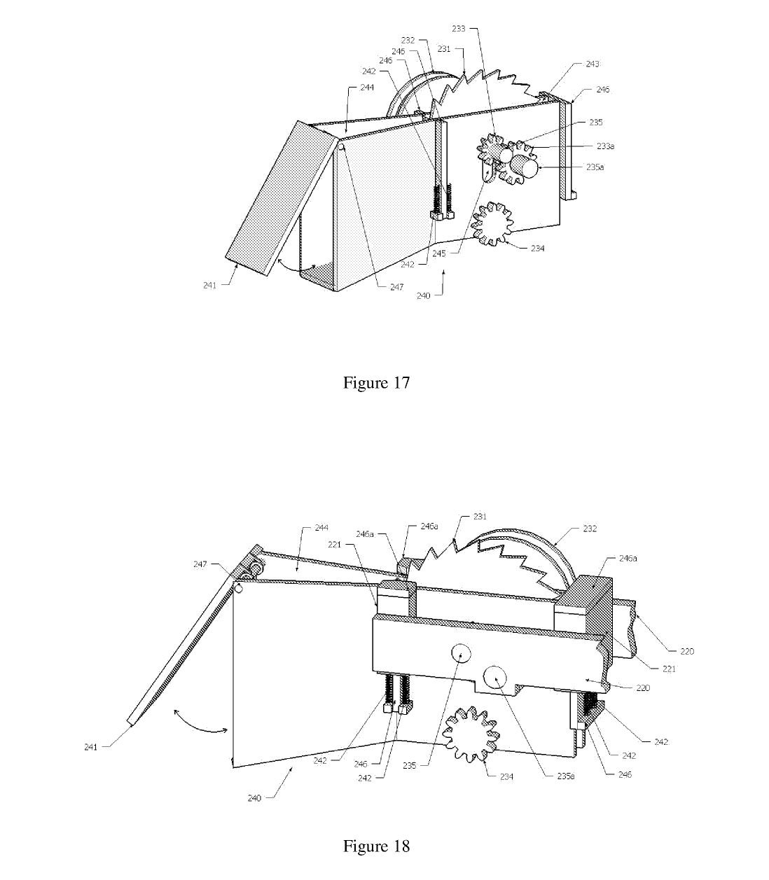

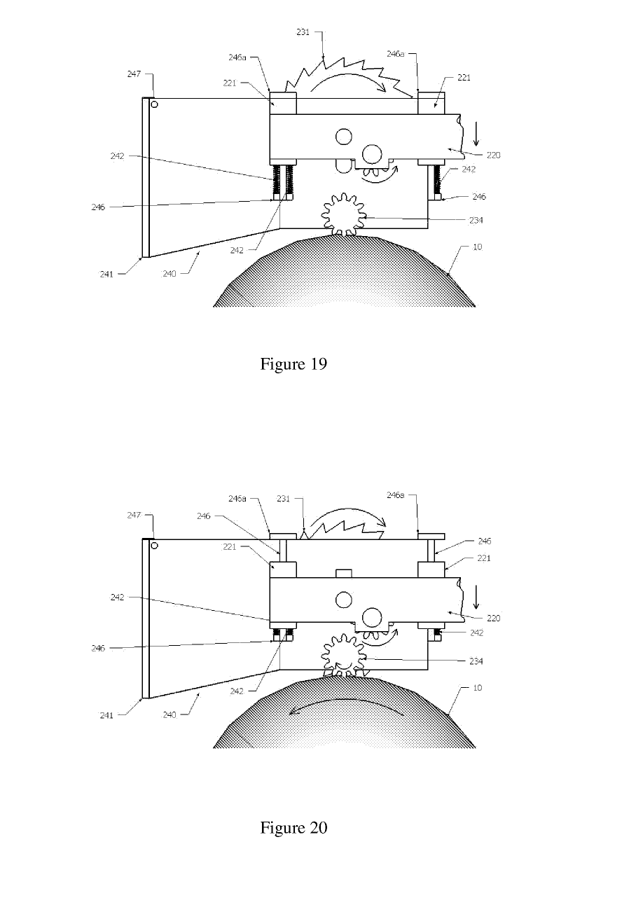

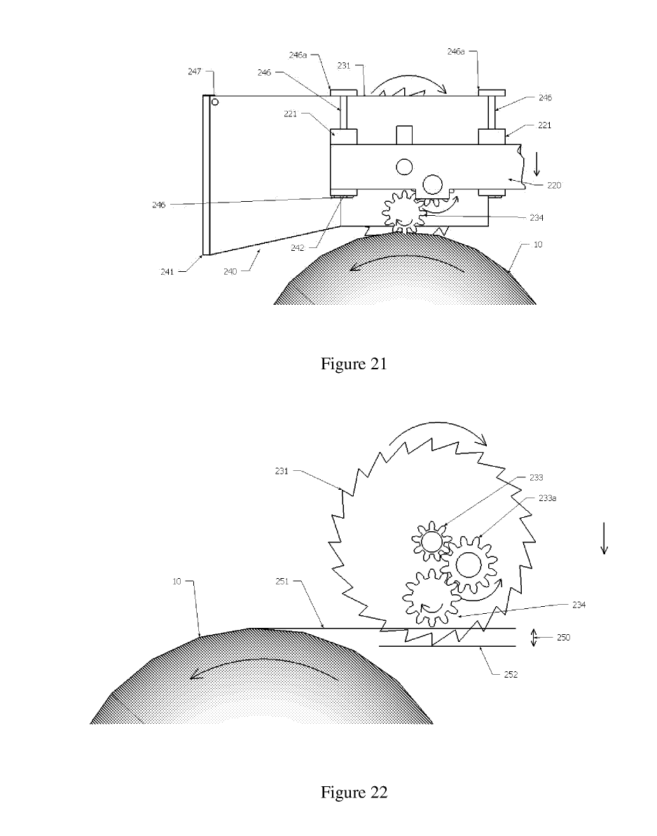

The cutter 200 shown in FIGS. 12-22 has a gear housing 210 and cutter assembly 230. The gear housing 210 includes a top housing ceiling 210a and a bottom housing floor 210b supported by a gear housing pane 211 and a gear housing pane slider 212. Gear housing 210 also includes a housing bearing 213 that tightly fits to the housing floor 210b, a first housing gear 215 that is connected by gear teeth to a second housing gear 216, a housing pulley 217 that is fixed to the second housing gear 216, a pulley belt 218 that is connected to the housing pulley 217, a plunger 219 that is attached to the housing ceiling 210a and frames 220.

The cutter assembly 230 includes a cutting blade 231 that is attached to a first cutter connecting rod 235 and used to cut the shell of coconut 10, a cutter pulley 232 that is connected to the housing pulley 217 through the pulley belt 218, a first cutter gear 233 that is attached to the first cutter connecting rod 235 and connected through gear teeth to a second cutter gear 233a and a second cutter connecting rod 235a.

The second housing gear 216 has a housing bearing inner 214 formed on its surface. A hole, i.e., the housing bearing inner hole 214a, passes through the housing bearing inner 214 and the second housing gear 216. The inner ring of the housing bearing 213 is fitted tightly with housing bearing inner 214.

The cutting blade 231, cutter pulley 232 and first cutter gear 233 are tightly fitted to the first cutter connecting rod 235 such that they all rotate together about the first cutter connecting rod 235. Similarly, the second cutter gear 233a is tightly fitted to the second cutter connecting rod 235a such that they rotate together. The first and second cutter connecting rods 235 and 235a pass freely through frames 220. The first and second cutter connecting rods 235 and 235a are connected through gear teeth such that when the cutter pulley 232 rotates clockwise cutting blade 231 also rotates clockwise while the first cutter gear 233a rotates anticlockwise. Accordingly, the connection between the second housing gear 216 and the second cutter gear 233a is such that when the second housing gear 216 is rotated in the horizontal plane, it makes the cutting blade 231 and the second cutter gear 233a rotate in the vertical plane.

Cutter pulley 232, housing pulley 217 and pulley belt 218 could be replaced by suitable gears. The objective simply being to transfer rotational power from the second housing gear 216 to the cutting blade 231.

The cutter 200 has a cutter guard 240 which is used for safety purposes. The cutter guard 240 includes a cutter guard dust collector 244 for collecting any debris or dust created when cutting a coconut shell, a cutter guard door 241 that can be used to access the cutter guard dust collector 244, a cutter guard blade space 243 for encasing the cutting blade 231, cutter guard springs 242, cutter guard rod space 245, cutter guard sliders 246, cutter guard door rod 247 and a driving gear 234. The driving gear 234 is fixed tightly to a cutter gear driving rod 236, which is then loosely fitted to either side of the cutter guard 240. This enables the driving gear 234 to rotate freely about the cutter guard 240.

The cutting blade 231 is placed inside the cutter guard blade space 243 and the first cutter connecting rod 235 passes through the cutter guard rod space 245. A slider frame 221 is secured to frames 220 and cutter guard sliders 246 slide inside slider frame 221. Guard slider blockers 246a are fixed to the top of the cutter guard sliders 246 to ensure that the cutter guard sliders 246 remain inside the slider frame 221 while being able to slide vertically up and down.

In use, the cutter 200 is placed above a coconut 10 and frames 220 are progressively pressed downward. The driving gear 234 is first to make contact with the coconut 10 while the cutting blade 231 remains encased in the cutter guard 240, rotating at a speed suitable to cut the coconut 10. As the cutter 200 is pushed further downwards the cutter guard 240 abuts the coconut and is prevented from moving any further. The cutter assembly 230, aided by the slider frame 221 sliding through the cutter guard sliders 246, continues to move downwards until it contacts the coconut 10. When the cutting blade 231 touches the coconut 10 at high speed there is a significant difference in speed between the teeth of the cutting blade 231 and the coconut shell. There is also in inertia for the coconut 10 to speed up rotation to catch up with the cutting blade 231. This results in slippage or a difference in speed between the cutting blade 231 and the coconut 10. This slippage aids in the coconut 10 being cut. Depending on the speed of rotation of the cutting blade 231 the slippage can be increased or decreased by making the opposed jaws 115 of the coconut clasper 100 more or less free to rotate. Contact with the rotating coconut 10 causes the driving gear 234 to rotate, thereby avoiding any unwanted resistance on the rotating coconut 10. As the cutter 200 moves further downward the cutting blade 231 makes a deeper cut and rotation of the coconut 10 becomes uneven as the cut becomes larger. When the cut in the coconut 10 becomes large enough, and cuts through the shell, the cutting blade 231 begins to cut a part of the soft coconut-meat. At this point the second cutter gear 233a, which rotates and also moves down along with the cutting blade 231, engages with the driving gear 234 causing driving gear 234 to start rotating it in the direction of the cutting blade 231. At this point, the driving gear 234, which presses against the surface of the coconut 10, and rotates at a much lower speed, blocks the second cutter gear 233a along with the cutting blade 231 from moving further downwards. The driving gear 234 presses hard against the surface of the coconut such as to cause it to rotate at a very low speed while the cutting blade 231 continues to rotate at high speed. This ensures the circumference around the coconut 10 is cut at its equator. The depth to which the cutting blade 231 can cut a coconut 10 is called the cutting depth 250 and is the difference between the lowest point of the cutting blade 231, defined as the cut lower 252, and the driving gear 234, defined as the cut upper 251. The depth of cutting can be predetermined as illustrated in FIG. 22.

Because the driving gear 234 is already rotating when it engages with the second cutter gear 233a damage to the gear teeth is minimal. The gear ratio between the first cutter gear 233, the second cutter gear 233a and the driving gear 234 is chosen such that a) the speed of the driving gear 234 is around 300 rpm and b) the speed difference between the second cutter gear 233a and the driving gear 234 is not much. The driving gear 234 does not cut the shell of the coconut 10 as it is thick and not designed to cut. The speed of rotation is also very low such that it enables the coconut 10 to rotate but not cut.

Once the coconut 10 is cut and the downward pressure on the frame 220 is removed, the cutting blade 231 along with the cutter assembly 230 moves up and the cutter guard 240 once again encases the cutting blade 231 due to the spring action of cutter guard springs 242.

Two driving gears 234 can be used on each side of the cutter guard 240 meaning there are four driving wheels in total. This ensures better balance when pressing the cutter guard 240 against the coconut 10.

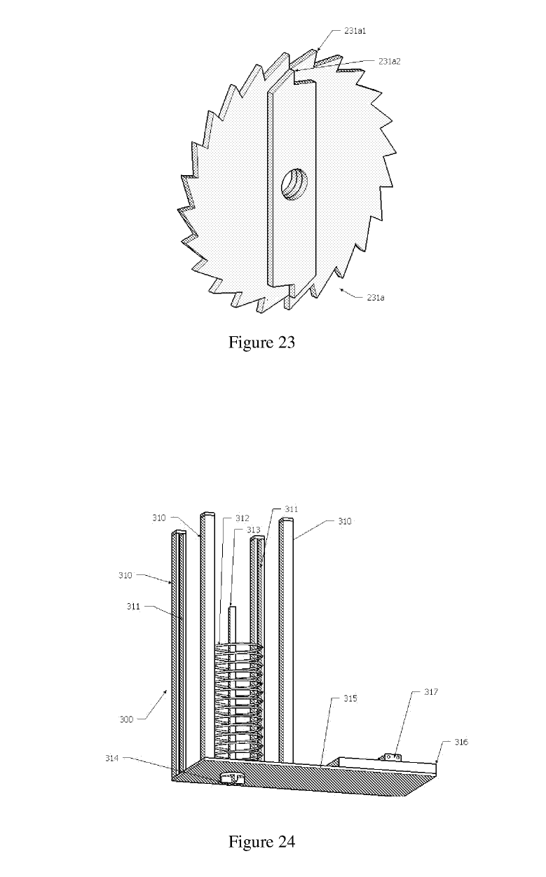

The cutting blade 231a shown in FIG. 23 is an alternate version of cutting blade 231, which includes outer cutting teeth 231a1 and inner marking teeth 231a2. The inner marking teeth 231a2 are on both faces of the cutting blade 231a. When this cutting blade 231a is used to cut into a coconut 10, and if the inner marking teeth 231a2 are limited to penetrate only to the depth of the coconut shell or less, it results in notches being made on coconut shell. Different kinds of notches can be made by changing the profile of inner marking teeth 231a2.

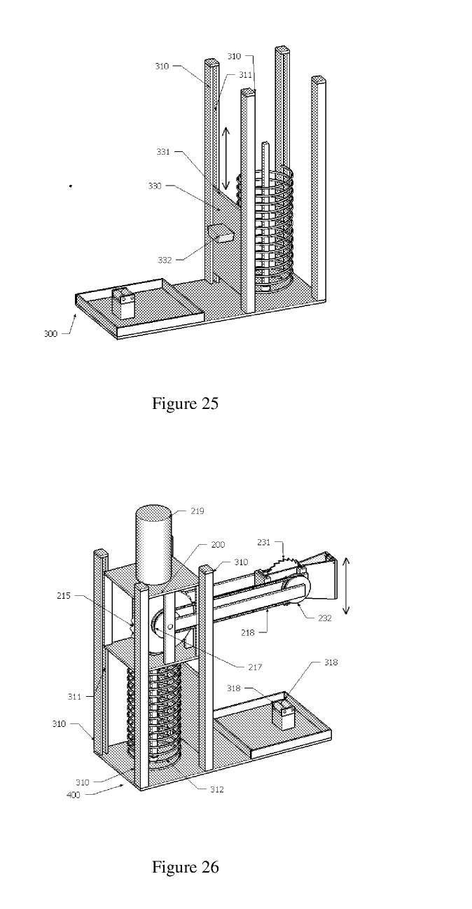

The support structure 300 shown in FIGS. 24-25 has four pillars 310 each with a pillar groove 311, a cutter spring 312 and a rotational rod 313 connected to a coupler 314. When the coupler 314 is connected to a rotational force it rotates the rotational rod 313. The support structure 300 also includes a base plate 315 that acts as a support for the water collector 316 and base support 317 that has two base support rollers 318. The support structure 300 around the clasper 100 may be enclosed in a protective cover (which is optionally transparent).

The coconut clasper 100 mounts on the support structure 300 via clasper connect 330 which has a clasper connect base plate 331, a male connector 332 and a connector lock that is a ball which can be depressed as it has a spring inside like in normal hand tools. The clasper connect 330 fits into two of the pillars 310 of the support structure 300. Here the edges of the clasper connect base plate 331 fit freely into the pillar grooves 311 such that it can easily slide up and down.

As shown in FIG. 26, the cutter 200 is mounted on the support structure 300 such that the gear housing pane sliders 212 fit freely into the pillar grooves 311 of pillars 310. When mounted in this way, the cutter 200 can slide vertically up and down within the pillars 310. This arrangement also ensures that the rotational rod 313 passes freely through the housing bearing inner hole 214a of the second housing gear 216, such that when the rotational rod 313 is rotating, the second housing gear 216 can freely move up and down as well as rotate. Accordingly, when coupler 314 is connected to a rotational force, it rotates the rotational rod 313, which in turn rotates the second housing gear 216, which in turn rotates the first housing gear 215, which in turn rotates the housing pulley 217, which in turn rotates the cutter pulley 232, which in turn rotates the cutting blade 231 such that it can cut through the shell of a coconut 10.

The lower-most tip of the cutting blade 231 is vertically above the gap between the two base support rollers 318. This is required to have optimum force distribution when the cutting blade 231 is pressed against the coconut 10. Alternatively, the lower-most tip of the cutting blade 231 can be slightly ahead or slightly behind along the “Y” Axis. The cutter 200 can be pushed down by applying downward pressure by hand using a plunger 219 resulting in compression of the cutter spring 312. When this downwards pressure is removed, the cutter 200 moves upwards due to the release in tension in cutter spring 312.

A method of using the device of the invention will now be described.

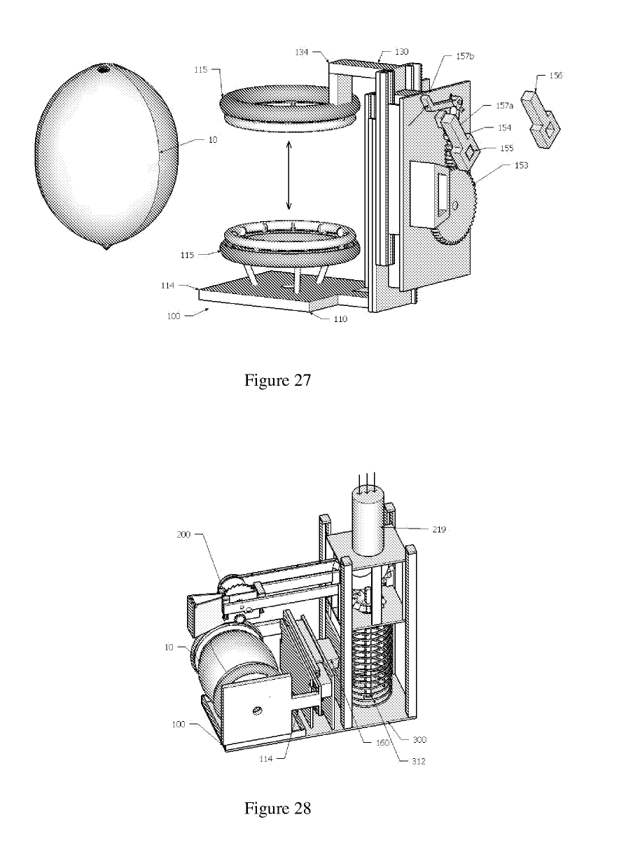

As shown in FIG. 27, to load a coconut 10 into the coconut clasper 100 the clasper is placed vertically with the large flat surface of forearm 114 as the base. In order to load coconut 10 into the coconut clasper 100 easily, the two jaws 115 need to be separated wider than the length of the coconut 10. This is achieved by pressing or applying pressure on lock lever flat end 157b to release the lock lever gear end 157a from the second gear 154. This results in the jaws 115 being free to move outward, which happens automatically due to the release spring 139 decompressing. The design of the jaws 115 enables easy visual inspection of the coconut 10 from top. This helps the user to align the coconut 10 correctly such that the pole aligns to the center of the jaw 115. The guide ribs 115_1d also aids in seating the coconut 10 vertically when pressed by the jaws 115 from either side. Vertically downward pressure is applied on forearm 134 such that coconut 10 is tightly held between both jaws 115. Due to the arrangement of the rack 111, the upper pinion 112 and the lower pinion 113 of forearm 114 and its connection to the lower pinion 133, the upper pinion 132 and the rack 131 of forearm 134, as forearm 134 moves downward, forearm 114 moves an equal distance upward (i.e., relative to forearm 134). This results in coconut 10 being held between both jaws 115 such that the imaginary equator of coconut 10 approximately coincides with the mid-point between both jaws 115. Key lever 156 is used to rotate keyin 155 to further bring the two jaws 115 closer in order to further tighten the hold on the coconut 10.

As shown in FIG. 28, once loaded with a coconut 10, the coconut clasper 100 is mounted to the support structure 300 by interaction of the male connector 332 on the clasper connect 330 with the female connector 160 on the coconut clasper 100. The connector lock of the male connector will help in locking this. The clasper connect 330 can go vertically up or down to aid easy connection. The alignment of the male and female connectors 332, 160 is such that when the coconut clasper 100 is mounted onto the support structure 300, the cutting blade 231 will correctly align to the mid-point of the distance between the two jaws 115. In addition, the coconut 10 of variable width will sit on the two base support rollers 318 such that its weight is almost evenly balanced.

In order to cut the coconut 10 the cutting blade 231 needs to rotate at the optimum speed. This is achieved by starting the rotational power source (not shown in figure). The cutter 200 is then lowered towards the coconut 10 by applying vertically downward pressure (for example, by hand) on the plunger 219. When the cutter 200 moves downward the cutter spring 312 gets compressed. The rotating cutting blade 231 cuts the shell of coconut 10 and causes it to rotate slightly. The blade 231 goes downward until the driving gear 234 touches the shell of the coconut 10. As driving gear 234 rotates the coconut 10, it ensures that the circumference around the coconut 10 is cut at the equator. The depth to which the coconut 10 needs to be cut can be decided by the vertical height difference between lowest point of the cutting blade 231 and the driving gear 234. It is ideal to keep this depth a little more than shell thickness of coconut 10 and such that the kernel of coconut 10 is not fully cut open. This ensures that water does not come out of coconut 10. Incase water comes out it will collect in the water collector 316. Base support 317 and base support rollers 318 are placed vertically below the cutting blade 231 so that the maximum vertical pressure which the cutting blade 231 exerts on the coconut 10 goes to the base support rollers 318 and base support 317. The rollers also aid in rotation. This ensures that there is not too much pressure on forearms 114 and 134 of the coconut clasper 100.

After cutting, the pressure on plunger 219 is removed, and due to the release in tension in cutter spring 312, the cutter 200 is moved vertically upwards. The coconut clasper 100 along with the clasped coconut 10 is unloaded from the support structure 300 and again placed vertically. Lock lever flat end 157b is pressed in to release the lock on outward movement of the jaws 115. The jaws 115 move away from each other and the cut coconut 10 removed. If the kernel is still intact, the coconut can be placed in a bowl and to cut through with a normal knife to get two halves of the coconut 10 and the coconut water collected in a bowl.

### LIST OF REFERENCE NUMERALS

10: coconut
100: coconut clasper
110: arm
111: rack
112: upper pinion
113: lower pinion
114: forearm
115: jaw
115a: outer portion
115b: support portion
115c: inner plate
115d: inner rod
115e: plate depression
115_1a: clasping ring
115_1b: bearing ring
115_1c: Bearing outer
115_1d: guide ribs
115_1e: bearing depression
115_1f: connection
115_1g: connection
116: back arm
117: railings
118: rod
130: arm
131: rack
132: upper pinion
133: lower pinion
134: forearm
136: back arm
137: railings
138: rod
139: release spring
140: spring peg
141: spring box
142: urging spring
150: back support
151: mid-point
153: first gear
154: second gear
155: keyin
156: key lever
157: lock lever
157a: lock lever gear end
157b: lock lever flat end
158: lock lever spring
159: spring holder
160: female connector
161: pivot
162: front cover
163: Railing support
200: cutter
210: gear housing
210a housing ceiling
210b housing floor
211: gear housing pane
212: gear housing pane slider
213: housing bearing
214: housing bearing inner
214a: housing bearing inner hole
215: first housing gear
216: second housing gear
217: housing pulley
218: pulley belt
219: plunger
220: frames
221: slider frame
230: cutter assembly
231: cutting Blade
231a: Cutting Blade
231a1: outer cutting teeth
231a2: inner marking teeth
232: cutter pulley
233: first cutter gear
233a: second cutter gear
234: driving gear
235: first cutter connecting rod
235a: second cutter connecting rod
236: cutter gear driving rod
240: cutter guard
241: cutter guard door
242: cutter guard springs
243: cutter guard blade space
244: cutter guard dust collector
245: cutter guard rod space
246: cutter guard sliders
246a: Guard slider blockers
247: cutter guard door rod
250: cutting depth
251: cut upper
252: cut lower
300: support structure
310: pillars
311: pillar groove
312: cutter spring
313: rotational rod
314: coupler
315: base plate
316: water collector
317: base support
318: base support rollers
330: clasper connect
331: clasper connect base plate
332: male connector
333: connector lock
360: manual turner

1. A device for cutting a coconut, the device comprising:
a support structure;
a coconut clasper mounted on the support structure and having a pair of opposed jaws adapted for clasping opposed ends of a coconut, each jaw being rotatable about an axis to permit rotation of a coconut clasped in the opposed jaws; and
a cutter mounted on the support structure and positioned for cutting a coconut clasped in the opposed jaws,
wherein the device includes a coconut centring mechanism to cause simultaneous movement of the opposed jaws to align the mid-point of a coconut clasped in the pair of opposed jaws with the position of the cutter, such that, in use, the cutter acts at approximately the mid-point of the coconut.

2. A device as claimed in claim 1, wherein the cutter is structured so as to cause rotation of a coconut clasped in the pair of opposed jaws of the coconut clasper as it acts on the coconut.

3. A device as claimed in claim 2, wherein the cutter includes cutting blade and driving gear, the cutting blade being structured and arranged so as to cut through a coconut, and the driving gear being adapted to engage with the surface of a coconut clasped in the pair of opposed jaws such as to control rotation of the coconut.

4. A device as claimed in claim 1, wherein the cutter includes adjustable limiting means, the limiting means being structured so as to limit the depth that the cutter can cut into a coconut clasped in the pair of opposed jaws, such that the kernel of the coconut is not cut through and water remains in the coconut.

5. A device as claimed in claim 1, further comprising a cutter guard mounted on the cutter and structured so as to encase at least a cutting edge of the cutter, the cutter guard being movable relative to the cutter so as to permit exposure of the cutting edge when it is brought into contact with a coconut clasped in the pair of opposed jaws.

6. A device as claimed in claim 5, wherein the cutter guard is detachable from the cutter.

7. A device as claimed in claim 5, wherein the cutter guard is configured to collect dust and debris created when a coconut is cut.

8. A device as claimed in claim 1, wherein the cutter has a cutting blade structured so as to pull dust and/or debris out of a cut as it is created during cutting.

9. A device as claimed in claim 1, wherein the cutter comprises a rotating disk having outer cutting teeth and inner marking teeth, the outer cutting teeth being adapted to cut through a coconut, and the inner marking teeth being configured such as to create notches in the shell of a coconut.

10. A device as claimed in claim 1, wherein the coconut clasper includes a locking means adapted to reversibly lock the opposed jaws in a clasping position, and the locking means optionally comprises a ratchet and pawl mechanism.

11. A device as claimed in claim 1, wherein the coconut clasper includes a release mechanism, resiliently biased such as to cause the opposed jaws to separate, and/or, the coconut centring mechanism comprises a rack and pinion mechanism.

12. A device as claimed in claim 1, wherein the opposed jaws are shaped such as to permit the opposed ends of a coconut to be visible when the coconut is clasped in the pair of opposed jaws.

13. A device as claimed in claim 1, wherein the opposed jaws include guide ribs structured and arranged such as to prevent slipping of a coconut 4 clasped in the pair of opposed jaws and to aid alignment of a coconut within the pair of opposed jaws.

14. A device as claimed in claim 1, wherein the coconut clasper includes urging means adapted to engage with one of the opposed jaws so as to urge the jaw into contact with a coconut clasped in the pair of opposed jaws (115).

15. A device as claimed in claim 1, wherein
the support structure includes at least one base support roller positioned for supporting a coconut clasped in the opposed jaws of the coconut clasper, the at least one base support roller being rotatable about an axis to aid rotation of a coconut clasped in the pair of opposed jaws; and
the coconut clasper is mounted on the support structure between the cutter and the at least one base support roller via a clasper connect, the clasper connect being movable relative to the at least one base support roller and the cutter, such that, in use, the coconut clasper is positioned such that the approximate mid-point of a coconut clasped in its jaws is supported by the at least one base support roller as the cutter acts at the approximate mid-point of the coconut.

16. A device as claimed in claim 1, comprising a rotational rod, connected at one end to a coupler and at the other end to a second housing gear, such that the second housing gear is rotated by the rotational rod and moves along the rotational rod linearly.

17. A device as claimed in claim 6, wherein the cutter guard is configured to collect dust and debris created when a coconut is cut.
